(19) United States
(12) Patent Application Publication
(10) Pub. No.: US 2014/0344697 A1
(43) Pub. Date: Nov. 20, 2014

(54) METHOD, APPARATUS AND TERMINAL FOR ADJUSTING PLAYBACK PROGRESS

(71) Applicant: Tencent Technology (Shenzhen) Company Limited, Shenzhen (CN)

(72) Inventors: Jing LIU, Shenzhen (CN); Xiaodan LIN, Shenzhen (CN)

(73) Assignee: Tencent Technology (Shenzhen) Company Limited, Shenzhen (CN)

(21) Appl. No.: 14/275,568

(22) Filed: May 12, 2014

Related U.S. Application Data
(63) Continuation of application No. PCT/CN2013/089060, filed on Dec. 11, 2013.

(30) Foreign Application Priority Data
May 14, 2013 (CN) 201310177852.3

(51) Int. Cl. G06F 3/0484; G06F 3/0488; G06F 3/0482

(52) U.S. Cl. CPC G06F 3/04842; G06F 3/0482; G06F 3/0488
USPC 715/720

(57) ABSTRACT

A method, apparatus, and terminal for a user of a touch screen electronic device to readily and conveniently adjust or control multimedia playback progress using the touch screen are disclosed. In some embodiments, a playback progress adjustment method includes: detecting a contact with a touch screen at a multimedia playback window by a device having a processor and a touch screen; acquiring by the device a touch parameter of the contact; determining that the contact is a single contact with the touch screen based on the touch parameter, wherein the single contact is a continuous contact, the touch parameters corresponding to the continuous contact comprises a start position parameter and an end position parameter; adjusting playback progress of the multimedia based on the touch parameters.

### CROSS-REFERENCE TO RELATED APPLICATIONS

This application is a continuation application of PCT Patent Application No. PCT/CN2013/089060, filed on Dec. 11, 2013, which claims priority to Chinese Patent Application No. 201310177852.3, filed on May 14, 2013, both of which are incorporated by reference in their entireties.

### FIELD OF THE TECHNOLOGY

The present disclosure relates to the field of multimedia playback, and particularly, to a playback progress adjustment method, apparatus and terminal.

### BACKGROUND

Nowadays, multimedia players are often used to play videos on touch screen devices, such as personal digital assistants, tablet computers and mobile telephones. One problem associated with using a multimedia player to play a video in a touch screen device is that a user need use toolbar controls or a video progress bar to adjust the playback progress. In order to display the best picture effect, the toolbar and progress bar are often automatically hidden when a video is played in a multimedia player.

In relevant technologies, the automatically hidden toolbar may cause inconvenience in operation. For example, when the player is used to adjust the playback progress of a video, a user needs to adjust the video playback position by either clicking the two buttons of ‘Fast Forward/Fast Backward (Rewind)’ or dragging the video playback progress bar, and because a toolbar is automatically hidden in playback status, the toolbar needs to be called out before the control buttons on the toolbar or the video progress bar may be operated. To call out the toolbar, one needs first click any position in the video playback window of the player, and if the toolbar cannot be called out, it is then impossible to operate the video being played in the player through the touch screen, which makes the operation more complicated.

For another example, in a mobile device having a touch screen, because the touch screen is small in size, the size of the corresponding toolbar and the sizes of the buttons on the toolbar are all small, a user has to click the control buttons or drag the progress bar very carefully in order to properly adjust the playback progress, which is not user-friendly.

### SUMMARY

A method, apparatus and terminal device are disclosed to readily and conveniently adjust or control multimedia playback progress using a touch screen.

In an aspect of the disclosure, a playback progress adjustment method may include: detecting, by a device having a processor and a touch screen, a contact with a touch screen, by a detecting module having a processor, at a multimedia playback window; acquiring, by the device, at least one touch parameter of the contact; determining, by the device, that the contact is a single contact with the touch screen based on the touch parameter, wherein the single contact is a continuous contact, and the touch parameter corresponding to the continuous contact comprises a start position parameter and an end position parameter; and adjusting, by the device, playback progress of the multimedia based on the touch parameter.

In an aspect of the disclosure, a device may include a touch screen, a processor and a non-transitory storage medium accessible to the processor, the non-transitory storage medium is configured to store: a detection module configured to detect a contact with a touch screen at a multimedia playback window; an acquisition module configured to acquire a touch parameter of the contact; a determination module configured to determine that the contact is a single contact with the touch screen based on the touch parameter, wherein the single contact is a continuous contact, and the touch parameter corresponding to said continuous contact comprises a start position parameter and an end position parameter; and an adjustment module configured to adjust playback progress of the multimedia based on the touch parameter corresponding to the single contact.

In another aspect of the disclosure, a non-transitory computer-readable storage medium comprises a set of instructions for adjusting playback progress, the set of instructions to direct at least one processor to perform acts of: detecting a contact with a touch screen at a multimedia playback window; acquiring at least one touch parameter of the contact; determining that the contact is a single contact with the touch screen based on the touch parameter, wherein the single contact is a continuous contact and the touch parameter corresponding to the continuous action comprises a start position parameter and an end position parameter; and adjusting playback progress of the multimedia based on the touch parameter.

In another aspect of the disclosure, a terminal device may include: a touch screen configured to display a multimedia playback window, and detect a contact with the touch screen; and a processor configured to acquire a touch parameter of the contact, determine that the contact is a single contact with the touch screen based on the touch parameter, and transmit control information to adjust playback progress of the multimedia based on the touch parameter, wherein the single contact is a continuous contact, and the touch parameter corresponding to said continuous contact comprises a start position parameter and an end position parameter.

The present disclosure detects a contact with a touch screen at a multimedia playback window; acquires a touch parameter of the contact; determines that the contact is a single contact with the touch screen based on the touch parameter, wherein the single contact is a continuous contact, and the touch parameter corresponding to the continuous contact comprises a start position parameter and an end position parameter; and adjusts playback progress of the multimedia based on the touch parameter. The present disclosure may simplify the operation of a multimedia player, and thus enhance user experience.

### BRIEF DESCRIPTION OF THE DRAWINGS

The accompanying drawings are included to provide a further understanding of the claims and disclosure, are incorporated in, and constitute a part of this specification. Apparently, the accompanying drawings in the following description are only some embodiments of the present disclosure, and persons of ordinary skill in the art may further derive other drawings according to these accompanying drawings without creative efforts. In the drawings:

FIG. 1 is a structural diagram of a playback progress adjustment apparatus according to an embodiment of the present disclosure.

FIG. 2 is a structural diagram of a first example embodiment for a playback progress adjustment apparatus according to the present disclosure.

FIG. 3 is a structural diagram of a second example embodiment for a playback progress adjustment apparatus according to the present disclosure.

FIG. 4 is a structural diagram of a third example embodiment for a playback progress adjustment apparatus according to the present disclosure.

FIG. 5 is a structural diagram of a terminal according to an embodiment of the present disclosure.

FIG. 6 is a flowchart for a playback progress adjustment method according to an embodiment of the present disclosure.

FIG. 7 is a diagrammatic sketch illustrating a video playback in the performance of a sliding gesture to adjust the playback backward or forward according to an embodiment of the present disclosure.

FIG. 8 is a diagrammatic sketch illustrating a web page with a video content according to an embodiment of the present disclosure.

FIG. 9 is a diagrammatic sketch illustrating a video playback window in full-screen mode according to an embodiment of the present disclosure.

FIG. 10 is a diagrammatic sketch illustrating a toolbar with video playback forward and backward buttons according to an embodiment of the present disclosure.

### DETAILED DESCRIPTION OF THE EMBODIMENTS

The various embodiments of the present disclosure are further described in details in combination with accompanying drawings and embodiments below. Like numbered elements in the same or different drawings perform equivalent functions. It should be understood that the specific embodiments described here are used only to explain the present disclosure, and are not intended to limit the present disclosure.

When describing a particular example, the example may include a particular feature, structure, or characteristic, but every example may not necessarily include the particular feature, structure or characteristic. This should not be taken as a suggestion or implication that the features, structure or characteristics of two or more examples, or aspects of the examples, should not or could not be combined, except when such a combination is explicitly excluded.

It should be appreciated that the methods described, the apparatus and the terminal shown in various embodiments of the present disclosure may be configured or embodied in computer-executable instructions; e.g., software, hardware, or in a combination of both, including one or more hardware processors, one or more non-transitory processor-readable storage media, and application specific integrated circuits. For the purposes of this specification, the term “computer” shall be taken to include, but not limited to, a general-purpose computer, a PC, a server, a mobile terminal, equipment using a Central Processing Unit (CPU), a single-chip microcomputer, a Digital Signal Processor (DSP) with a processing chip, or the like. It should also be appreciated that there are no special requirements for the operating systems of computers or mobile terminals/devices. Alternatively, the operations might be performed by specific hardware components that contain instructions for performing the operations described, or by any combination of programmed computer components and custom hardware components that are recognized by those of ordinary skill in the art.

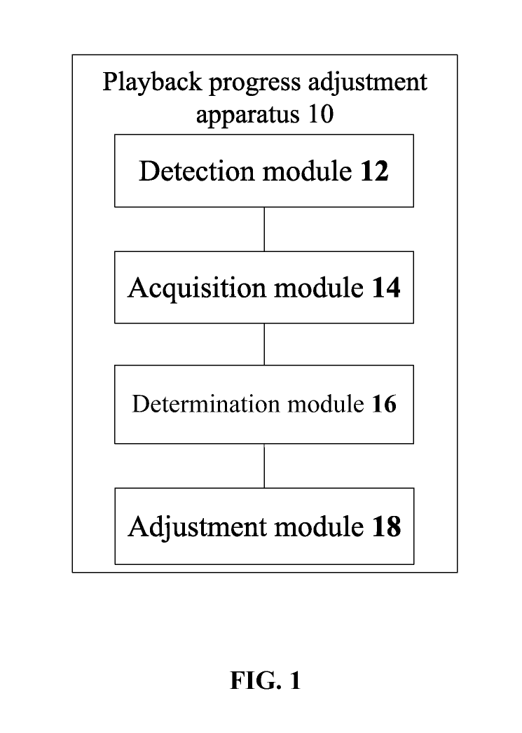

FIG. 1 is a structural diagram of a playback progress adjustment apparatus according to an embodiment of the present disclosure. As shown in FIG. 1, in an example configuration, a playback progress adjustment apparatus 10 in FIG. 1 at least comprises: a detection module 12, an acquisition module 14, a determination module 16 and an adjustment module 18. The detection module 12 at a multimedia playback window uses a processor and is configured to detect the contact with a touch screen. The acquisition module 14, coupled to the detection module 12, uses a processor and is configured to acquire the touch parameter of the contact. The determination module 16, coupled to the acquisition module 14, uses a processor and is configured to determine that the contact is a single contact with the touch screen based on the touch parameter, where the single contact is a continuous contact, the touch parameter corresponding to the continuous contact comprises a start position parameter of the contact and an end position parameter of the contact. The adjustment module 18, coupled to the determination module 16, uses a processor and is configured to adjust the multimedia playback progress based on the touch parameter corresponding to the single contact.

Through the aforesaid apparatus, the contact may be determined to be a single contact via the detected touch parameter, and the multimedia playback progress is adjusted on the basis of the touch parameter of the single contact, which simplifies the operation of a multimedia player by removing the use of a toolbar in the relevant state of the art, and further enhances user's experience.

Through the apparatus, whenever a user performs one operation on the screen, such as performing one slide, the corresponding progress may be adjusted, which enhances the user's experience. There are many methods to detect a single contact. For example, the start position for contacting the screen and the position for leaving the screen as detected may be recorded, and if the user's contact with the screen is continuous between these two positions, it may be deemed as a single contact.

The modules and units as involved in the present embodiment may be realized by software, hardware, or in a combination of both. The modules and units as described in the present embodiment may also use a processor. For example, the hardware processor may perform acts according to instructions in a non-transitory storage medium comprising a detection module 12, an acquisition module 14, a determination module 16, and an adjustment module 18. The names of these modules should not constitute limitations of the modules. For example, the detection module may also be described as “the module at the multimedia playback window using a processor and configured to detect a contact with a touch screen.”

When the adjustment module 18 adjusts the multimedia playback progress based on the touch parameter, multiple modes may be used. Three example apparatuses are included in the present embodiment. One of ordinary skill in the art would appreciate that there are numerous apparatuses that could be included with the present disclosure, and the embodiments of the present disclosure may be used in combination. In one embodiment, the single contact is a click, wherein the values of the aforesaid start position parameter and end position parameter corresponding to the click are the same. With each click, the multimedia playback progress is accordingly adjusted for a certain length, and multiple clicks may achieve multiple playback progress adjustments, which enhances user experience.

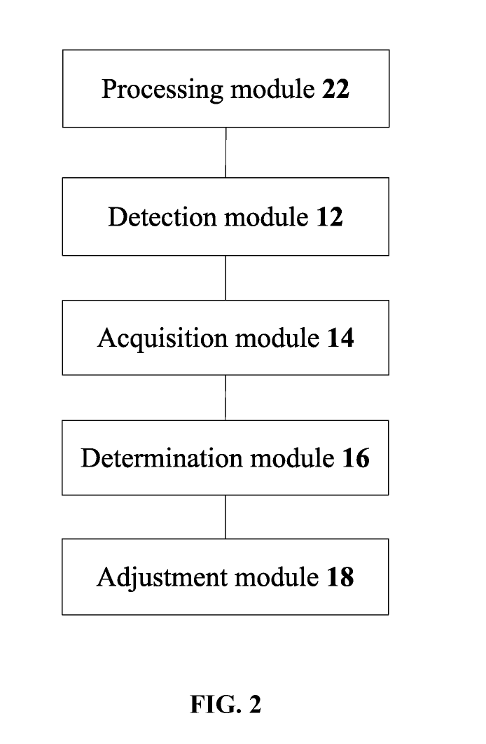

Preferably, to make it more convenient for the user, the setup function may be provided, so that the user is allowed to individually set the multimedia playback length that may be adjusted through a single contact. FIG. 2 is an example structural diagram I for the playback progress adjustment apparatus according to an example embodiment of the present application, and as shown in FIG. 2, the aforesaid playback progress adjustment apparatus may further comprise: a processing module 22, coupled to the detection module 12, is configured to receive the adjustment length corresponding to the single contact as set by the user, and save the adjustment length.

For example, a user may set 5 minutes as the length that may be adjusted at a single contact. In an example, the following setup may be provided: Within a preset length of time, different adjustment lengths are set for the single contacts continuously detected. For example, the preset length of time may be set to 3 minutes, and within the 3 minutes, if a single contact is detected for the first time, the adjustment length thereof is 5 minutes; within the 3 minutes, if a single contact is detected for the second time, the adjustment length thereof is 10 minutes; within the 3 minutes, if a single contact is detected for the third time, the adjustment length thereof may be set to 15 minutes. The reason for using such setup is that, if the user continuously adjusts the time progress within a short period of time, it has reflected the willingness of the user to expect accelerated multimedia playback to a certain degree, and therefore, setting a different adjustment length for each of the multiple contacts occurring within a preset period of time will better meet the habit of the user.

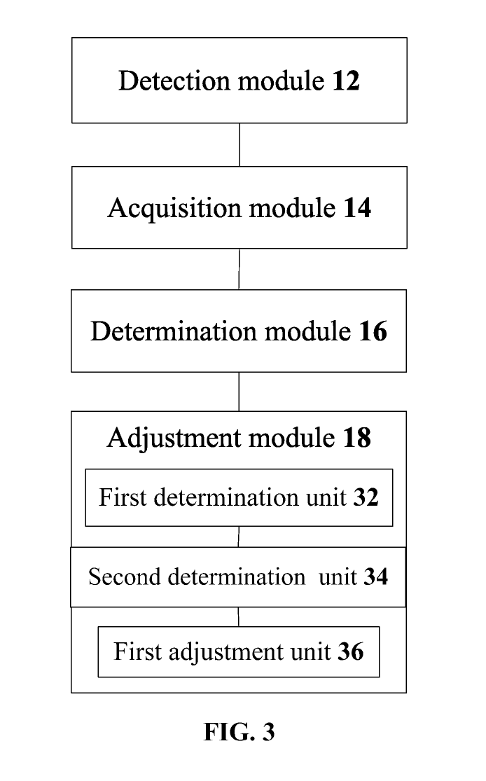

FIG. 3 is an example structural diagram II for the playback progress adjustment apparatus according to another embodiment of the present application. As shown in FIG. 3, preferably, the aforesaid adjustment module 18 comprises: a first determination unit 32, a second determination unit 34 and a first adjustment unit 36, wherein the first determination unit 32 uses a processor and is configured to determine a forward or backward adjustment of the playback progress based on the movement direction parameter in the touch parameter; the second determination unit 34 is coupled to the aforesaid first determination unit 32, uses a processor and is configured to determine an adjustment length for the playback progress based on the movement distance parameter in the touch parameter; the first adjustment unit 36 is coupled to the aforesaid second determination unit 34, uses a processor and is configured to adjust the multimedia playback progress based on the adjustment length.

In one embodiment, the mode for adjusting the playback progress based on the movement distance is used. In an example embodiment, the straight-line distance of this movement may be calculated on the basis of the difference between the coordinates of the start position and the end position as detected, and the length of the adjustment is determined by comparing the straight-line distance with one or more threshold values. For example, if the straight-line distance is more than 2 centimeters, the adjustment is made for 5 minutes, and if the straight-line distance is more than 3 centimeters, the adjustment is made for 3 minutes. Alternatively, the movement distance may also be determined on the basis of other units, such as pixels. In another example embodiment, the actual movement distance may also be used to determine the adjustment length, such as when the movement track on the screen is a camber line, and at this time, the distance of the movement may be determined on the basis of the actual length of the camber line, and the length for the adjustment is then determined on the basis of comparison with threshold values. There are many methods to calculate the length of the camber line, and this example may be realized by using whichever method of calculation, which will not be further described here.

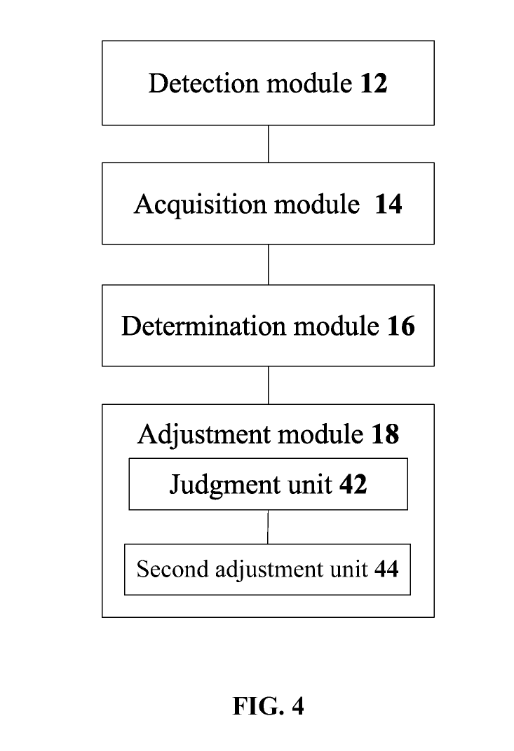

FIG. 4 is an example structural diagram III for the playback progress adjustment apparatus according to another embodiment of the present application. As shown in FIG. 4, preferably, the aforesaid adjustment module 18 comprises: a judgment unit 42 and a second adjustment unit 44, wherein the judgment unit 42 uses a processor and is configured to determine whether the touch parameter corresponds to a preset parameter, wherein the preset parameter comprises at least one of the following: a movement direction parameter of the contact, a movement distance parameter of the contact, a movement track parameter of the contact, the start position parameter of the contact, the end position parameter of the contact. The second adjustment unit 44 is coupled to the aforesaid judgment unit 42, uses a processor and is configured to adjust the multimedia playback progress based on the touch parameter if the touch parameter corresponds to the preset parameter.

Through the example apparatus, it may be determined whether or not a detected contact is used to adjust the playback progress. For example, if the contact as detected is within the preset range of the screen, the contact is then deemed as being used for adjusting the playback progress. The range may be determined on the basis of at least one of the parameters such as the start position and the end position of the contact. For another example, it may also be determined whether or not the contact is used to adjust the playback progress on the basis of the movement track of the contact, and preferably, if the length of the track is smaller than a certain threshold value, the contact is then deemed as not being used for adjusting the playback progress; for example, it is possible that the contact is used to call out the toolbar. At this time, operations may be performed on the toolbar to adjust the playback progress.

It should be appreciated that the functions of the various modules in the aforesaid example embodiments are not limited to the functions individually described in the corresponding example modes. For example, the functions of the adjustment module 18 in the aforesaid example modes may also be combined as long as there is no conflict. For example, an adjustment module 18 may simultaneously include the first determination unit 32, the second determination unit 34, the judgment unit 42 and the second adjustment unit 44. One of ordinary skill in the art would appreciate various combinations of these functions and unnecessary details for the modes of these combinations will not be further described here.

Preferably, when the multimedia playback progress is adjusted, multiple modes may be used for expression of the aforesaid adjustment length, for example, the adjustment length per percentage of the total playback time of the multimedia, time unit or number of frames.

The aforesaid example embodiments may be used in combination. In addition, as used in the present disclosure, the term “module” or “unit” may include various software programs and/or sets of instructions stored in the memory and to be executed by one or more processors on the playback progress adjustment apparatus 10. Different modules and units described here may be realized as the software program or process executed (for example, as an individual thread) on the playback progress adjustment apparatus 10, and at the same time, the aforesaid playback progress adjustment apparatus 10 may also be realized by use of software, hardware or a combination of both.

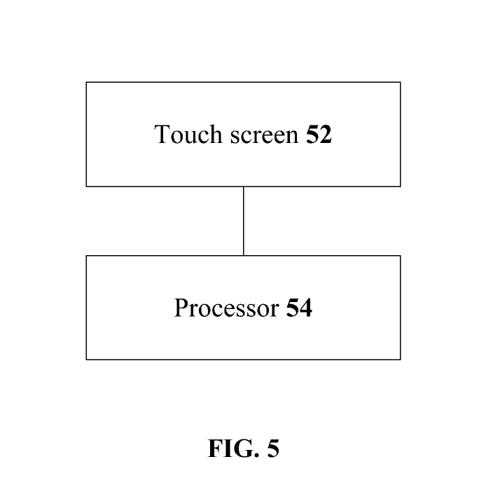

The functions as realized by the aforesaid playback progress adjustment apparatus 10 may be realized in a terminal device. Modules and units as involved in the adjustment apparatus of the aforesaid embodiment may be realized by the hardware in the terminal, such as one or more processors. A terminal device is also provided in the present embodiment. FIG. 5 is a structural diagram of a terminal device according to an embodiment of the present disclosure. As shown in FIG. 5, the terminal comprises: a touch screen 52 and a processor 54, wherein the touch screen 52 is set to display the multimedia playback window, and detect the contact with the touch screen; the processor 54 is coupled to the aforesaid touch screen 52, and is set to acquire the touch parameter of the contact, determine that the contact is a single contact with the touch screen based on the touch parameter, and transmit the control information based on the touch parameter corresponding to the single contact, wherein the single contact is a continuous contact, the touch parameter corresponding to the continuous contact comprises the start position parameter and the end position parameter, and the control information is configured to adjust the playback progress of the multimedia.

Preferably, the processor 54 may also be configured to receive an adjustment length corresponding to the single contact, and save the adjustment length, before detecting the contact with the touch screen.

In the aforesaid embodiment of the playback progress adjustment apparatus 10, several example modes are described, and in the present embodiment, the acquisition module 14, the determination module 16 and the adjustment module 18 in the aforesaid embodiment as well as the functions of the various units in the adjustment module 18 may all be realized in the processor, which means that the aforesaid terminal may also realize all the functions of the aforesaid playback progress adjustment apparatus 10. Because the various example modules and units have been described above, they will not be further described in the present embodiment.

The present embodiment also provides a playback progress adjustment method, and the descriptions involved in the method may also be described and explained in combination with the functions corresponding to the aforesaid apparatus.

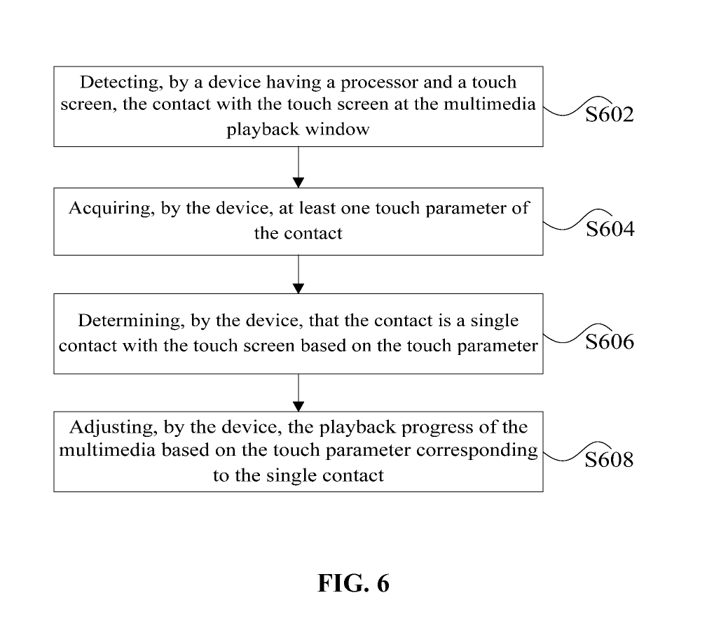

FIG. 6 is a flowchart for a playback progress adjustment method according to another embodiment of the present application, and as shown in FIG. 6, the method comprises the following steps:

Step S602, detecting, by a device having a processor and a touch screen, a contact with the touch screen at a multimedia playback window;

Step S604, acquiring, by the device, the touch parameter of the contact;

Step S606, determining, by the device, that the contact is a single contact with the touch screen based on the touch parameter, wherein the single contact is a continuous contact, the touch parameter corresponding to the continuous contact comprises the start position parameter and the end position parameter;

Step S608, adjusting, by the device, the playback progress of the multimedia based on the touch parameter corresponding to the single contact.

Through the aforesaid steps, the contact may be determined to be a single contact via the detected touch parameter, and the multimedia playback progress is adjusted on the basis of the touch parameter of the single contact, and in this way, the adjustment of the multimedia playback progress may be realized directly through touch operation of the multimedia playback window, which may simplify the operation of the multimedia player by removing the use of a toolbar in the relevant state of the art, and enhance user experience.

In the aforesaid method, a single contact is used to adjust the corresponding playback progress length; for example, a single contact may control a certain length for the fast forwarding or fast backwarding of the playback progress (for example, 5 seconds, 1% of the total playback time, or 100 frames), and the adjustment of a more extended length of playback progress may be realized through multiple single contacts. In the method, the continuous touch with the start position parameter and the end position parameter in the touch parameter is determined to be a single contact.

More preferably, in the aforesaid method, when adjustment is made to the multimedia progress, there is no need to call out the toolbar configured to adjust various functions of the multimedia, which has thus brought about a better user experience.

There are many modes for making adjustment to the multimedia playback progress based on the touch parameter; three example modes are included in the present embodiment, and the three example modes are described below.

Preferably, the aforesaid contact is a click, wherein the values of the aforesaid start position parameter and end position parameter corresponding to the click are the same. It means that one click may also be taken as a single contact. Through this mode, with each click, the multimedia playback progress is accordingly adjusted for a certain length, and multiple clicks may achieve multiple playback progress adjustments, which enhances user experience.

Preferably, the length of the playback progress to be adjusted by the aforesaid single contact may be user-defined. A setup mode is provided in the method, which is to receive the user-defined adjustment length corresponding to the single contact before detecting the contact with the touch screen, and save it. Through the method, a single contact is made to match a corresponding adjustment length based on the need of the user; for example, a single contact adjusts 10 seconds, 20 seconds or 300 frames, so as to meet the need of the user and enhance the user experience.

In another embodiment, a method is provided to determine whether the playback progress should be adjusted forward or backward based on the movement direction of the touch. For example, a continuous touch moving from the left to the right may be made to correspond to the forward adjustment of the playback progress, and a continuous touch moving from the right to the left may be made to correspond to the backward adjustment of the playback progress. Obviously, it is also feasible to have such a setup so that a continuous touch moving from the left to the right corresponds to the backward adjustment of the playback progress, and a continuous touch moving from the right to the left corresponds to the forward adjustment of the playback progress. In addition, the directions of the touch movement are not only limited to the left and right directions, and they may also be the upward and downward directions or the two directions along either of the diagonal lines of the screen. It should be noted that the movement direction as described above only indicates the tendency for the direction of the touch movement; the tendency is determined on the basis of the touch parameter, and it should not be understood that the movement must follow a straight line or a specific curve.

At the same time, another mode for adjusting the playback progress length may be further provided in the present embodiment. The adjustment length of the playback progress can be determined on the basis of the movement distance parameter in the touch parameter. For example, in a continuous contact, each 5 mm horizontal shift of the contact to the right corresponds to an adjustment of the playback progress for a length of 5 seconds, and under this circumstance, for example, if the rightward horizontal shift of a continuous contact is 20 mm, it corresponds to an adjustment of the playback progress for a length of 20 seconds. Obviously, the adjustment length of the playback progress corresponding to the length of the shift is not thus limited, and may be set up per a user's need, and a setup method may also be provided in the present embodiment to set up the aforesaid correspondence relationship.

When playing the multimedia, sometimes, for other purposes, such as to prevent against erroneous operation, the validity of the contact operation may be determined first. The present embodiment may also include a method to determine the validity of the contact operation, i.e., to determine whether or not the touch parameter corresponds to a preset parameter, wherein the preset parameter comprises at least one of the following: a movement direction parameter of the contact, a movement distance parameter of the contact, a movement track parameter of the contact, the start position parameter of the contact, the end position parameter of the contact. The multimedia playback progress is adjusted on the basis of the touch parameter if the touch parameter corresponds to a preset parameter. For example, judgment is made on whether or not the contact starts at the preset position through the touch parameter. If it does not start at the preset position, it is deemed as being an invalid touch operation, and no response is made to the contact at this time; if it is determined to start at the preset position, it is deemed as being a valid operation, and a response is made to the contact operation at this time. The modes for application of other parameters are similar to the aforesaid examples, and will not be further described here. It should be noted that determination of whether or not the contact is a valid contact can also be made by determining whether the touch parameter of the contact is in conformity with more than one of the aforesaid preset parameters.

It should also be noted that the aforesaid embodiments may be used in combination under the condition of no conflict. For example, one embodiment is used in combination with another embodiment so that the combined solution may realize the effects of both embodiments at the same time, and may also prevent against erroneous operation and enhance user experience at the same time. The other modes of combination will not be further described here.

In an embodiment, multiple ways can be used to adjust the playback progress.

The multimedia playback progress may be adjusted per percentage of the total playback time of the multimedia. For example, the sliding adjustment of the playback progress with each user-defined gesture (i.e. the contact in conformity with the preset parameter) is set at N % (wherein N is a positive number smaller than 100) of the total time length of the multimedia, namely at one sliding with the user-defined gesture, it moves forward or backward at N % of the total time length of the multimedia (such as audio and video) per the playback progress as represented by the sliding. For example, a film may be as long as 120 minutes; if the user adjusts the playback progress according to this mode, and sets the rightward sliding to be 5% forward movement of the film, one rightward sliding by the user will move the playback forward by 120*5%=6 minutes.

The multimedia playback progress may also be adjusted per time unit; for example, the sliding adjustment of the playback progress with each user-defined gesture is set at a time unit of N seconds, namely at one sliding with the user-defined gesture, the playback progress moves forward or backward by N seconds. For example, a film may be as long as 120 minutes; if the user adjusts the playback progress according to this mode, and sets the rightward sliding to be a forward movement by 120 seconds, when the user executes rightward sliding, the video playback will be moved forward by 120 seconds.

The multimedia playback progress may also be adjusted per number of frames; therein, the number of frames refers to the number of frames for the pictures transmitted in 1 second; for example, the sliding adjustment of the playback progress with each user-defined gesture is set at a certain number of frames for pictures; namely at one sliding with the user-defined gesture, the playback progress moves forward or backward by N seconds. For example, the length of playback time for a video may be 10 minutes, and there are a total of 9,000 frames (15 frames per second, 600 seconds*15 frames/second=9,000 frames). If the user adjusts the playback progress according to this mode, and sets the rightward sliding to be a forward movement by 150 frames, when the user executes rightward sliding, the video playback will be moved forward by 10 seconds.

These three different forms as cited above are targeted at the playback progress adjustments for different multimedia and may have their own advantages respectively. For example, when a user wishes to perform precise positioning of the multimedia pictures by using frame picture as the unit, the mode for adjusting the multimedia playback progress per number of frames may be used. for another example, if the total time length of the multimedia is relatively long and the user only needs to briefly browse the general content of the multimedia, the selection of the mode for adjusting the multimedia playback progress per percentage of the total playback time of the multimedia would be more convenient and quicker. Preferably, the procedures for the aforesaid adjustment may also be displayed on the touch screen.

It should be appreciated that the contact mode used in the aforesaid embodiments and example modes is not just limited to the mode of single-point touch control, mode of multi-point touch control may also be used. In the case of multi-point touch control, it generally refers to the situation in which one of the contacts has the characteristics as cited above, while the contacts other than this one may remain static or move with the characteristics as cited above.

It should also be appreciated that the steps shown in the flowchart of the attached drawings may be executed in a computer system such as that with a group of computer-executable instructions. Although an example logical sequence is shown in the flowchart, under certain circumstances, the steps as shown or described may be executed in a sequence different from the one here.

Preferably, the present application may also provide a computer program configured to execute the aforesaid embodiments and a carrier for storage of the aforesaid computer program, namely the aforesaid embodiments of the present application may perform run procedures in conformity with natural law through a suitable computing architecture. In addition, although the present application is described in the aforesaid context, the aforesaid computer program configured to realize the execution steps is not meant to be limited, and the various aspects of the actions and operations as described may be realized through hardware as well.

The theory of the present application may be operated by using other general or specific computing or communication environments or configurations. Examples of the universally known computing systems, environments and configurations applicable to the present application include, but are not limited to, a personal computer, a server, a multi-processor system, a microprocessor-based system, a minicomputer, a mainframe computer, an intelligent device, a terminal (including, but not limited to, a mobile terminal) as well as a distributed computing environment comprising any of the aforesaid systems or devices.

Descriptions are presented below in combination with example embodiments.

In a example embodiment, the adjustment functions of the playback progress bar commonly used in multimedia playback are further described, wherein a function is provided for realization of the playback progress adjustment for video playback through leftward or rightward sliding by way of gestures on the touch screen equipment, which is referred to as “fast forward” or “fast backward” below. Because the characteristic of an interactive solution in the past is to realize the fast forward or fast backward of the video playback by using the “Forward” or “Backward” button or the playback progress bar, and the toolbar also needs to be called out in the full-screen status so that the buttons and the progress bar may appear, the operation is inconvenient, and the user's fast forward or fast backward operation is simplified by way of gesture sliding in the present example embodiment.

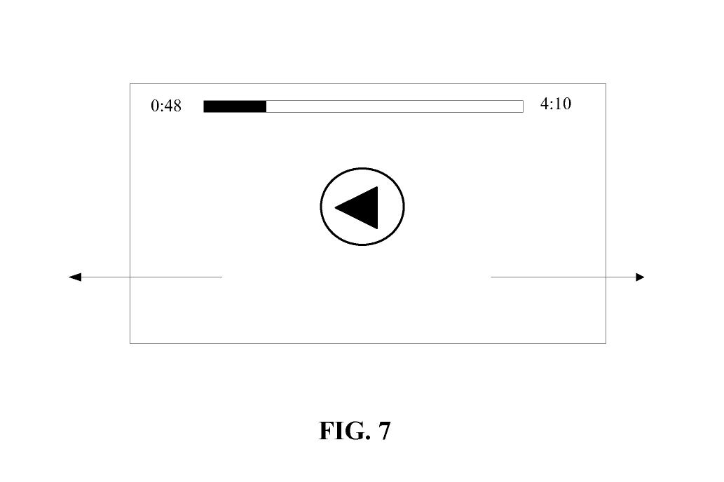

The present example embodiment relates to functions that support gesture sliding such as a third-party video application (Application, briefly referred to as “APP”) or a browser client on a touch screen terminal. FIG. 7 is a diagrammatic sketch illustrating a video playback in the performance of a sliding gesture to adjust the playback fast backward or fast forward according to an embodiment of the present disclosure. As shown in FIG. 7, the leftward sliding is fast backward, and the rightward sliding is fast forward.

In the technical solution of the present example embodiment, gesture sliding may trigger a single fast forward or fast backward, and two modes may be used for the frequency of fast forward or fast backward: One mode is to use percentage, namely a single sliding moves forward or backward by N % (N is a positive number between 0 and 100) of the length of playback time, and the other mode is to use the number of seconds, namely a single sliding moves forward or backward by M seconds (M is a positive number). The video APP or browser may individually decide which mode to use and the size of N and M values.

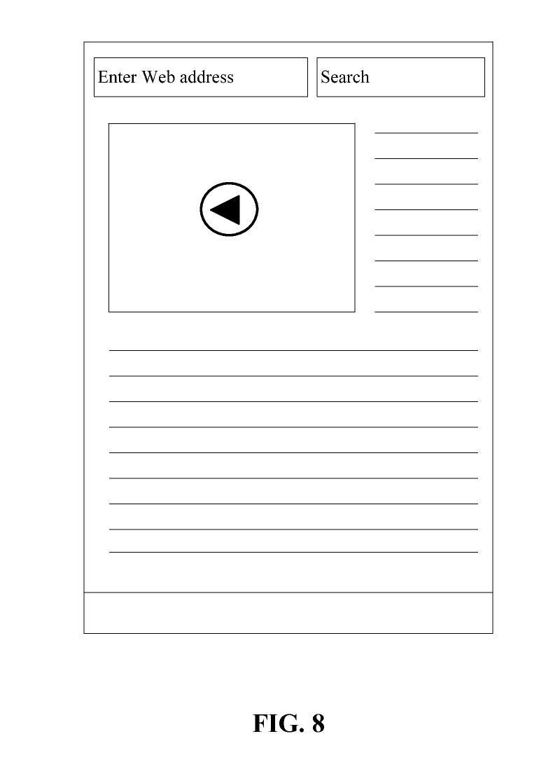

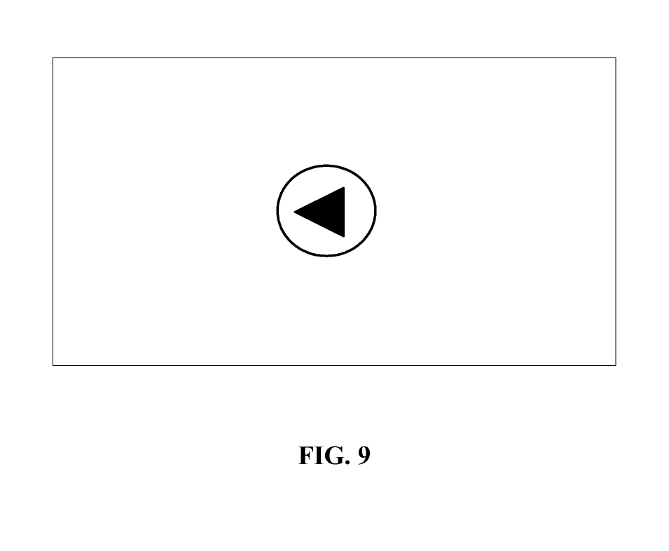

FIG. 8 is a diagrammatic sketch illustrating a web page with a video content according to an embodiment of the present disclosure. FIG. 9 is a diagrammatic sketch illustrating a video playback window in full-screen mode according to an embodiment of the present disclosure, and FIG. 10 is a diagrammatic sketch illustrating a toolbar comprising video playback forward and backward buttons according to an embodiment of the present disclosure. It should be appreciated that, regardless of which mode the video playback is in, and regardless of whether or not the toolbar is called out, the embodiments as described above and the example embodiment modes may all be realized.

Preferably, the aforesaid gesture sliding may be user-defined. For example, a user may design it in a way so that the leftward sliding is the fast backward of the video, the rightward sliding is the fast forward of the video, the upward movement is the fast playback of the video preceding the current video, and the downward movement is the fast playback of the next video. Moreover, a user may individually draw several specific patterns to represent specific operations. Through realization of the fast forward or fast backward of video playback by way of user-defined gesture sliding, a user may individually set up the video sliding gesture in line with personal operation, which enhances the user's experience.

By using the aforesaid technical solution of the present example embodiment, after a user clicks the video for playback and enters the video playback window in full-screen mode, the user does not need to click the full-screen video position to call out the upper and/or lower toolbars, but directly slides leftward or slides rightward in the full-screen interface to fast forward or fast backward the video, which simplifies the operation and enhances the user's experience.

In another example embodiment, a function is provided for realization of the playback progress adjustment for audio playback through leftward or rightward sliding by way of gesture on the touch screen equipment, and the sound volume adjustment in the audio playback process is realized through drawing circles with gestures.

In the technical solution of the present example embodiment, the functions of fast forwarding and fast backwarding that may be triggered by gestures are the same as those of the previous example embodiment, and will not be further described here. In the present example embodiment, if what is detected is a circling action, for example, if two contact points coincide in the detected touch track, the gesture may be deemed as an enclosed curve, and it may be deemed as a circling gesture, and judgment is then made on whether the circling is in the clockwise direction or the counterclockwise direction, wherein one direction is to increase sound volume and the other direction is to decrease sound volume.

Obviously, those of ordinary skill in the art should understand that the aforesaid various modules or various steps of the present disclosure may be implemented in a general computing apparatus. The various modules or steps of the present disclosure may be centralized on a single computing apparatus, or distributed on a network including multiple computing apparatuses. Alternatively, they may be realized by using computing apparatus-executable program codes, which may be stored in a storage memory executed by a computing apparatus. Alternatively, they may also be implemented by hardware including one or more signal processors, various integrated circuits. Further, multiple modules or steps among them may be made into a single integrated circuit module. In this way, the present application is not limited to any specific hardware, software, or a combination of both hardware and software.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

What is claimed is:

1. A method for adjusting playback progress, comprising:
detecting, by a device having a processor and a touch screen, a contact with the touch screen at a multimedia playback window;
acquiring, by the device, at least one touch parameter of the contact;
determining, by the device, that the contact is a single contact with the touch screen based on the touch parameter, wherein the single contact is a continuous contact and the touch parameter corresponding to the continuous action comprises a start position parameter and an end position parameter; and
adjusting, by the device, playback progress of the multimedia based on the touch parameter.

2. The method according to claim 1, wherein the device determines that the contact is a click when the values of the start position parameter and the end position parameter are the same.

3. The method according to claim 1, wherein, before detecting the contact with the touch screen, the method further comprises:
receiving an adjustment length corresponding to the single contact; and
saving the adjustment length.

4. The method according to claim 1, wherein the adjusting playback progress of the multimedia based on the touch parameter further comprises:
adjusting the playback progress forward or backward based on a movement direction parameter in the touch parameter; and
adjusting the playback progress based on an adjustment length, wherein the adjustment length is determined on the basis of a movement distance parameter in the touch parameter.

5. The method according to claim 1, wherein the adjusting playback progress of the multimedia based on the touch parameter further comprises:
determining whether the touch parameter corresponds to a preset parameter, wherein the preset parameter comprises at least one of the following: a movement direction parameter of the single contact, a movement distance parameter of the single contact, a movement track parameter of the single contact, the start position parameter of the single contact, and the end position parameter of the single contact;
if the touch parameter corresponds to the preset parameter, adjusting the playback progress of the multimedia based on the touch parameter.

6. The method according to claim 3, wherein the adjustment length comprises one of the following:
the adjustment length per percentage of a total playback time of the multimedia;
the adjustment length per time unit; and
the adjustment length per number of frames.

7. A device, comprising a touch screen, a processor, and a non-transitory storage medium accessible to the processor, the non-transitory storage medium is configured to store:
a detection module configured to detect a contact with the touch screen at a multimedia playback window on the touch screen;
an acquisition module configured to acquire a touch parameter of the contact;
a determination module configured to determine that the contact is a single contact with the touch screen based on the touch parameter, wherein the single contact is a continuous contact, and the touch parameter corresponding to the continuous contact comprises a start position parameter of the contact and an end position parameter of the contact; and
an adjustment module configured to adjust playback progress of the multimedia based on the touch parameter.

8. The apparatus according to claim 7, wherein the determination module determines that the contact is a click when the values of the start position parameter and the end position parameter are the same.

9. The apparatus according to claim 7, further comprising:
a processing module configured to receive an adjustment length corresponding to the single contact, and save the adjustment length.

10. The apparatus according to claim 7, wherein the adjustment module further comprises:
a first determination unit configured to determine a forward or backward adjustment of the playback progress on the basis of a movement direction parameter in the touch parameter;
a second determination unit configured to determine an adjustment length of the playback progress on the basis of a movement distance parameter in the touch parameter; and
a first adjustment unit configured to adjust the playback progress of the multimedia on the basis of the adjustment length.

11. The apparatus according to claim 7, wherein the adjustment module comprises:
a judgment unit configured to determine whether the touch parameter corresponds to a preset parameter, wherein the preset parameter comprises at least one of the following: a movement direction parameter of the single contact, a movement distance parameter of the single contact, a movement track parameter of the single contact, the start position parameter of the single contact, and the end position parameter of the single contact;
a second adjustment unit configured to adjust the playback progress of the multimedia based on the touch parameter if the touch parameter corresponds to the preset parameter.

12. The apparatus according to claim 9, wherein the adjustment length comprises one of the following:
the adjustment length per percentage of a total playback time of the multimedia;
the adjustment length per time unit; and
the adjustment length per number of frames.

13. A non-transitory computer-readable storage medium comprising a set of instructions for adjusting playback progress, the set of instructions to direct at least one processor to perform acts of:
detecting a contact with a touch screen at a multimedia playback window;
acquiring at least one touch parameter of the contact;
determining that the contact is a single contact with the touch screen based on the touch parameter, wherein the single contact is a continuous contact and the touch parameter corresponding to the continuous action comprises a start position parameter and an end position parameter; and
adjusting playback progress of the multimedia based on the touch parameter.

14. The non-transitory computer-readable storage medium according to claim 13, wherein the contact is a click when the values of the start position parameter and the end position parameter are the same.

15. The non-transitory computer-readable storage medium according to claim 13, further comprising receiving an adjustment length corresponding to the single contact, and saving the adjustment length, before detecting the contact with the touch screen.

16. The non-transitory computer-readable storage medium according to claim 13, wherein the adjusting playback progress of the multimedia based on the touch parameter comprises:
adjusting the playback progress forward or backward based on a movement direction parameter in the touch parameter; and
adjusting the playback progress based on an adjustment length, wherein the adjustment length is determined on the basis of a movement distance parameter in the touch parameter.

17. The non-transitory computer-readable storage medium according to claim 13, wherein the adjusting playback progress of the multimedia based on the touch parameter comprises:
determining whether the touch parameter corresponds to a preset parameter, wherein the preset parameter comprises at least one of the following: a movement direction parameter of the single contact, a movement distance parameter of the single contact, a movement track parameter of the single contact, the start position parameter of the single contact, and the end position parameter of the single contact;
if the touch parameter corresponds to the preset parameter, adjusting the playback progress of the multimedia based on the touch parameter.

18. The non-transitory computer-readable storage medium according to claim 15, wherein the adjustment length comprises one of the following:
the adjustment length per percentage of a total playback time of the multimedia;
the adjustment length per time unit; and
the adjustment length per number of frames.
